(19) United States
(12) Patent Application Publication
(10) Pub. No.: US 2006/0095240 A1
(43) Pub. Date: May 4, 2006

(54) System and Method for Placement of a Packer in an Open Hole Wellbore

(75) Inventors: Francis Elisabeth, Villahermosa (MX); Philippe Gambier, Houston, TX (US); Patrick J. Hooyman, Richmond, TX (US); Donald W. Lee, Houston, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/163,691

(22) Filed: Oct. 27, 2005

Related U.S. Application Data
(60) Provisional application No. 60/522,698, filed on Oct. 28, 2004.

(51) Int. Cl. G06G 7/48

(52) U.S. Cl. 703/10

(57) ABSTRACT

A system and method enables optimization of placement of a packer in a wellbore, such as an open hole wellbore. The optimization of packer placement comprises an evaluation of the Earth formation failure modes.

### CROSS-REFERENCE TO RELATED APPLICATION

The present document is based on and claims priority to U.S. provisional application Ser. No. 60/522,698, filed Oct. 28, 2004.

### BACKGROUND

The invention generally relates to a system and method to place a packer in a wellbore. More specifically, the invention relates to a system and method to optimize the placement of a packer in an open hole wellbore.

The properties of the earth in which a wellbore is formed vary along the length of the wellbore. Earth properties may depend on depth and the type of rock or earth that comprises the different layers. Shale, sand, hydrocarbon bearing formations, water-bearing formations, and sandstone are all different formation types having different properties that may be found along the length of a wellbore.

Some of the layers may comprise weak formation regions that are prone to tensile failure (which may result in formation fractures) or shear failure (which may result in the production of sand from the formation). If a packer is positioned and set in a weak formation region, the additional pressure exerted due to the setting and presence of the packer against the wellbore wall can result in a well failure. For example, the well can collapse, downhole equipment can be damaged if sand is produced, and/or isolation across zones may be broken.

### SUMMARY

The present invention comprises a system and method to optimize the placement of a packer in an open hole wellbore. The optimization of packer placement takes into account the stability of formation regions and thus the risk of rock formation failure during the life of the well.

### BRIEF DESCRIPTION OF THE DRAWINGS

Certain embodiments of the invention will hereafter be described with reference to the accompanying drawings, wherein like reference numerals denote like elements, and:

FIG. 1 is a flowchart illustrating an optimization methodology for locating a packer in a wellbore, according to one embodiment of the present invention;

FIG. 2 is a schematic illustration of a processor based system for carrying out the optimization methodology, according to an embodiment of the present invention;

FIG. 3 is a schematic illustration of the processor based system illustrated in FIG. 2 along with certain program modules that can be utilized in optimizing packer placement, according to an embodiment of the present invention;

FIG. 4 is a schematic illustration of a modeling technique for modeling a well formation region, according to an embodiment of the present invention;

FIG. 5 is a graphical illustration of a finite element analysis of pertinent properties of a reservoir formation, according to an embodiment of the present invention;

FIG. 6 is a graphical illustration of an output from the processor based system illustrated in FIG. 2 reflecting projected changes in a reservoir formation over a period of well operation; and

FIG. 7 is a graphical illustration of an output from the processor based system illustrated in FIG. 2 reflecting a failure mode at a potential packer location.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a system and methodology for optimizing potential packer locations within a wellbore. The system and methodology utilize, for example, Earth modeling techniques, finite element analysis, and well life modeling techniques to facilitate selection and verification of optimal locations for placement of one or more packers. The system and methodology are particularly amenable for analyzing potential modes of failure, e.g. shear failure or tensile failure, in an open hole wellbore, thus facilitating the determination of optimal packer placement regions along the wellbore.

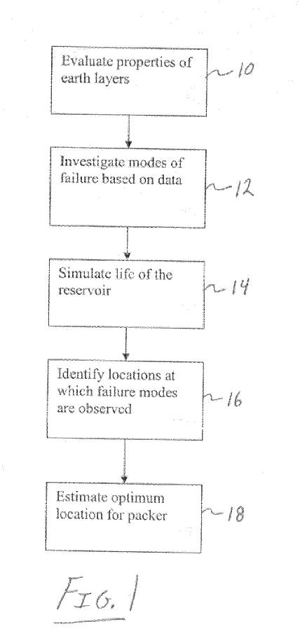

Referring generally to FIG. 1, a method to optimize the placement and/or verify the viability of an open hole packer in an open hole section of a wellbore is illustrated. The wellbore is formed in a reservoir that may contain hydrocarbon based fluids. Initially, data related to properties of Earth formations is evaluated, as illustrated by block 10. The evaluation and calibration of formation properties may be done on, for example, petrophysical, rock strength and stress properties of the earth layers of the reservoir using known modeling techniques. Examples of such techniques include Mechanical Earth Modeling, available as a service through Schlumberger Corporation, or available as a software program through other vendors, as known to those of ordinary skill in the art.

Subsequently, the resulting data from the earth formation evaluation is inserted into a model that investigates different modes of failure, e.g. tensile failure, shear failure, and compaction failure, for the different earth layers, as illustrated by block 12. An acceptable modeling program is a finite element analysis program, such as the ABAQUS finite element analysis program available commercially. Additionally, the life of the reservoir can be simulated by a reservoir simulator program, such as ECLIPSE, available from Schlumberger Corporation. The reservoir simulator program can be used to simulate changes in properties caused by, for example, a change in stresses in the reservoir, as illustrated by block 14. Depending on the specific well, the simulation can be done for a depletion application and/or injection application.

Use of finite element analysis with reservoir simulation enables determination of failure modes, as illustrated by block 16. For example, an identification of drawdown/build up pressure and the location at which different failure modes are observed can be identified for different formation layers along the wellbore in which the open hole packer is to be set. Once the modes of potential failure along the wellbore are identified, the optimum location for the packer can be estimated, as illustrated by block 18. This optimization is enabled by identifying the locations which are likely to undergo formation failure. Additionally, the reservoir life simulation in combination with the finite element analysis enables a better understanding of the safe drawdown of the reservoir before incurring likely modes of failure. Following selection of an optimal location or locations, a packer can be positioned in the wellbore at that location.

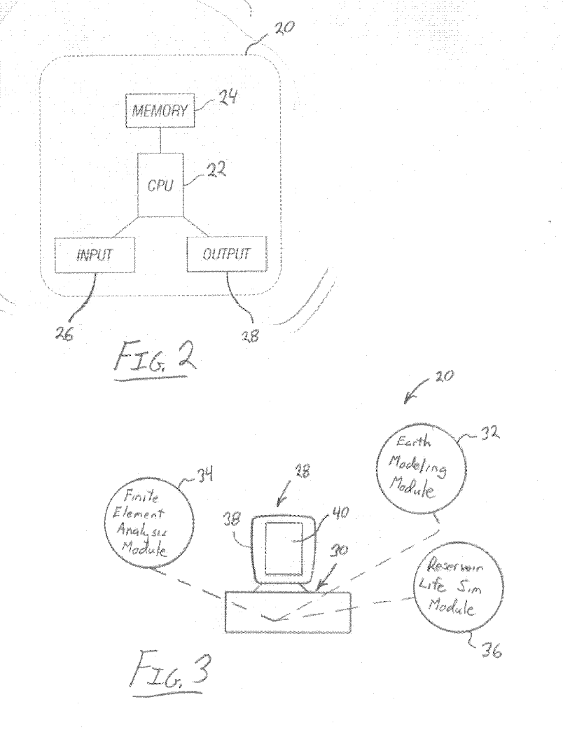

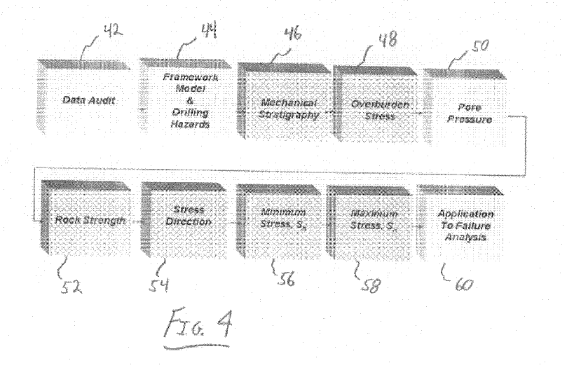

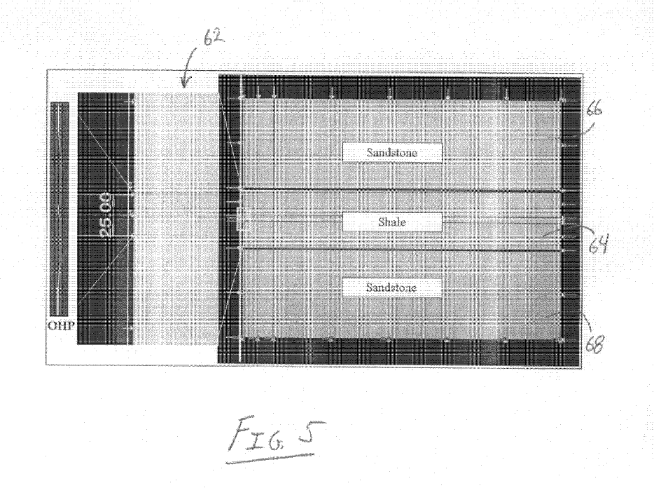

Some or all of the methodology outlined with reference to FIG. 1 may be carried out by an automated system 20, such as the processing system diagramatically illustrated in FIG. 2. Automated system 20 may be a computer-based system having a central processing unit (CPU) 22. CPU 22 is operatively coupled to a memory 24, as well as an input device 26 and an output device 28. Input device 26 may comprise a variety of devices, such as a keyboard, mouse, voice-recognition unit, touchscreen, other input devices, or combinations of such devices. Output device 28 may comprise a visual and/or audio output device, such as a monitor having a graphical user interface. Additionally, the processing may be done on a single device or multiple devices at the well location, away from the well location, or with some devices located at the well and other devices located remotely.

For example, automated system 20 may comprise a computer-based system having at least one computer 30. The at least one computer 30 comprises or has access to an Earth modeling module 32, a finite element analysis module 34 and a reservoir simulator module 36 by which the methodology described with reference to FIG. 1 is carried out. Each of the modules 32, 34 and 36 may be formed as a software program run by system 20 either locally or from a remote location. In this example, output device 28 comprises a monitor 38 by which information and results can be displayed to a user via a graphical user interface 40.

Evaluation of the petrophysical, rock strength and stress properties of the earth layers using modeling techniques, e.g. mechanical Earth modeling techniques, takes into consideration data related to reservoir characteristics such as Earth stresses, stress directions and magnitudes, and rock mechanics properties. Earth stress profiles include magnitudes of the vertical stress Sv (the weight of the overburden); the pore pressure Pp (pressure of fluids in rock pores); and the horizontal stresses SH and Sh. Principal stress directions include azimuths of maximal and minimal horizontal effective stresses (SH and Sh, respectively). Mechanical material properties include, for example, rock compressive and tensile strength, Poisson's ratio, and Young's modulus (static elastic properties).

An example of a workflow sequence in a mechanical Earth modeling technique is provided with reference to FIG. 2. As illustrated, steps in a mechanical Earth model workflow may comprise an initial data audit, as illustrated by block 42, followed by establishing a framework model and drilling hazards, as illustrated by block 44. Additional reservoir related data is entered and evaluated, including data on mechanical stratigraphy (see block 46), overburden stress (see block 48), pore pressure (see block 50), rock strength (see block 52), stress direction (see block 54), minimum stress, Sh, (see block 56), and maximum stress, SH, (see block 58). Once the data is entered and processed according to the mechanical Earth modeling technique for the specific reservoir, the properties of the reservoir can be used in failure mode analysis, as illustrated by block 60.

For example, with the mechanical Earth model constructed and run on automated system 20, an operator is able to discriminate between different earth formations, such as shale formations, water bearing formations, and oil bearing formations, each having distinct properties at different depths. The properties of these different formations or layers are then used to investigate the potential modes of failure of the different earth formation layers. For example, the finite element analysis module is used to model the formations and their potential failure modes along the wellbore.

In many well applications, formation fluids are either being depleted or additional fluids are being injected. Two failure mechanisms that can occur during injection and depletion are tensile and shear failure. The rupture of a formation by shear failure leads to particulates referred to as fines which can damage downhole equipment if transported through the equipment. Tensile failure, on the other hand, may open or reopen fractures in the formation that enable communication between isolated and non-isolated zones along the wellbore. Tensile failure can be predicted using calibration from leak-off tests, datafrac tests, tensile induced fractures from images, or time lapse resistivities. Rupture by tensile failure occurs when the maximum tensile stress within the rock overcomes the tensile strength T of the rock.

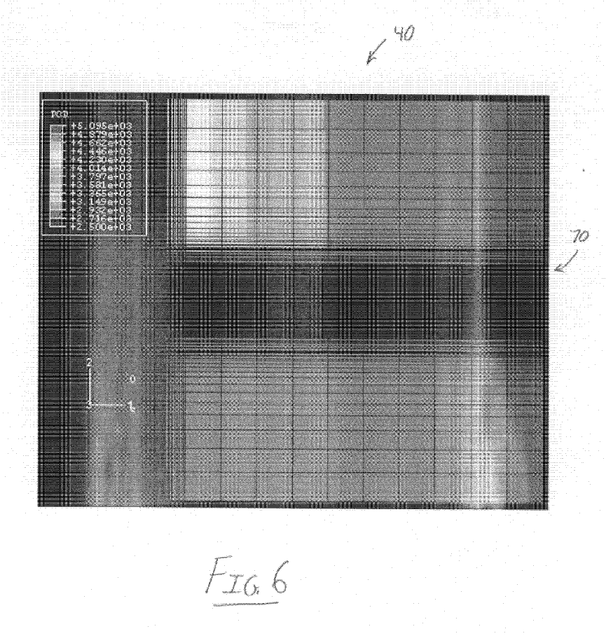

Modes of failure, such as tensile failure and shear failure, can be predicted by performing a finite element analysis of the formation or formations along the wellbore based on properties of the wellbore obtained by the mechanical Earth modeling technique. A graphical representation of a finite element analysis along a wellbore is illustrated in FIG. 5 in which an axisymmetric finite element geometry of a wellbore 62 is shown. In this example, a shale formation or layer 64 is illustrated as disposed between an upper sandstone formation or layer 66 and a lower sandstone formation or layer 68. The finite element analysis program is able to identify potential modes of failure for specific regions along the wellbore 62, either under current conditions or under projected conditions such as those established by performing a reservoir life simulation for a life of injection and/or depletion. The results of the finite element analysis and the projected failure modes for regions long wellbore 62 can be output to a well operator through an appropriate output device 28 having, for example, a user interface enabling both the numeric and graphical portrayal of information.

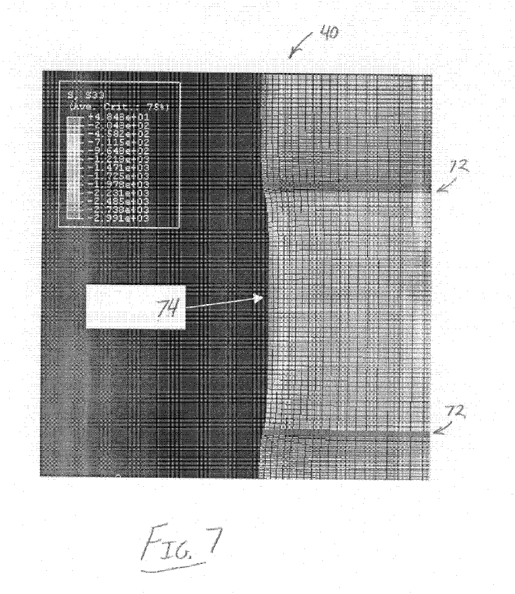

The specific information output to a well operator can be adjusted or selected based on operator preferences. However, examples of information output over graphical user interface 40 are illustrated in FIGS. 6 and 7. FIG. 6, for example, illustrates output of information based on reservoir life modeling performed on system 20. In this example, a pore pressure profile 70 of a formation is shown during depletion of the reservoir being modeled. However, a variety of other useful outputs can be selected by the operator, including numerical or graphical output of principal stresses and strains along the wellbore, relative invariants, such as Von Mises and Tresca, and thermal stresses and strains.

In FIG. 7, another example of information that may be output to a well operator is illustrated. In this graphical representation, a failure mode 72 is graphically output to graphical user interface 40. The illustrated failure mode 72 is based on the optimization methodology of collectively preparing mechanical Earth models, conducting finite element analysis, and/or conducting reservoir life simulations, as described above. In this embodiment, failure mode 72 is a shear failure mode at a specific location 74 analyzed for potential placement of an open hole packer. Based on this information, a well operator would not place the packer at location 74. Rather, other wellbore locations are examined for potential modes of failure, and optimal locations are selected based on formation regions having a reduced chance of formation failure while still achieving the desired result of packer placement, e.g. isolation of specific formations.

In many well situations, the wellbore operator may model each wellbore for both injector applications and producer applications to determine failure modes for the different formation layers and, for example, the pressure at which such layers are projected to fail. Based on this information, the operator is able to optimize the location of an open hole packer, thereby avoiding or reducing the chance of formation failure. The modeling also can be used to take into account the inclusion of additional forces incurred against the open hole wellbore during setting of the packer.

The use of an automated system, such as processor based system 20, facilitates great flexibility in carrying out the methodology described above. The computer system 30, for example, can be used to run different modules 32, 34 and 36 or different steps of the various modules, while also requesting relevant information from the operator, e.g. input of reservoir related data required for modeling. The combined computer system and graphical user interface also facilitates the easy identification of locations likely to incur a failure mode if a packer is set at that location. Moreover, the computer system enables a very rapid modeling of each wellbore, and the rapid calculation for each wellbore of the likelihood for formation failure. The potential for formation failure is readily evaluated at multiple locations along a plurality of Earth layers. Such automated systems also facilitate the outputting of failure prediction in a variety of formats while permitting the saving and transference of such information.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method to identify the desired placement of a packer in a wellbore, comprising:
evaluating properties of Earth formations along an open hole wellbore;
investigating modes of failure of the Earth formations based on the properties;
identifying locations at which the modes of failure are observed; and
positioning a packer in the open hole wellbore in an optimal location based on the identification of areas susceptible to failure.

2. The method as recited in claim 1, wherein positioning comprises positioning the packer in the wellbore to avoid the locations at which the failure modes are observed.

3. The method as recited in claim 1, further comprising simulating production of a fluid through the wellbore.

4. The method as recited in claim 1, further comprising simulating injection of a fluid into the wellbore.

5. The method as recited in claim 1, wherein evaluating comprises evaluating properties with a computer-based system.

6. The method as recited in claim 1, wherein investigating comprises determining modes of failure through finite element analysis.

7. A method of optimizing placement of a packer in an open hole wellbore, comprising:
processing characteristics related to Earth formations along an open hole wellbore on a computer-based system to determine pertinent properties of the Earth formations;
using the pertinent properties to perform a finite element analysis with the computer-based system; and
determining an optimal location for an open hole packer based on results of the finite element analysis.

8. The method as recited in claim 7, further comprising simulating a life of the wellbore to obtain pertinent properties of the Earth formation based on a future period.

9. The method as recited in claim 7, further comprising simulating production through the wellbore to obtain pertinent properties of the Earth formation based on a future period.

10. The method as recited in claim 7, further comprising simulating injection through the wellbore to obtain pertinent properties of the Earth formation based on a future period.

11. The method as recited in claim 7, further comprising positioning an open hole packer at the optimal location.

12. The method as recited in claim 7, wherein using comprises performing the finite element analysis to determine a failure mode based on shear failure in the Earth formations.

13. The method as recited in claim 7, wherein using comprises performing the finite element analysis to determine a failure mode based on tensile failure in the Earth formations.

14. The method as recited in claim 7, further comprising verifying conditions at which failure modes occur at different layers of the Earth formations.

15. A system for optimizing packer placement in a wellbore, comprising:
a processor based system having an Earth modeling module to determine pertinent properties of an Earth formation in which a wellbore is formed, and a finite element analysis module, wherein the pertinent properties are processed by the finite element analysis module to determine an optimal wellbore location for placement of a packer.

16. The system as recited in claim 15, wherein the processor based system further comprises a well simulator module able to project the pertinent properties at a future period.

17. The system as recited in claim 15, wherein the processor based system further comprises a well simulator module able to project the pertinent properties at a future period following production in the wellbore.

18. The well system as recited in claim 15, wherein the processor based system further comprises a well simulator module able to project the pertinent properties at a future period following injection in the wellbore.

19. The well system as recited in claim 15, further comprising a packer positioned in the wellbore at the optimal wellbore location.

20. A method, comprising:
evaluating with an Earth modeling technique data related to a reservoir having an open hole wellbore;
processing the data via finite element analysis;
determining failure modes of the reservoir based on the finite element analysis; and
using the failure modes to determine at least one optimal packer placement location in the open hole wellbore.

21. The method as recited in claim 20, further comprising simulating the life of the reservoir to project changes to the data.

22. The method as recited in claim 20, further comprising placing a packer at the at least one optimal packer placement location.

23. The method as recited in claim 20, wherein determining comprises determining a failure mode based on shear failure.

24. The method as recited in claim 20, wherein determining comprises determining a failure mode based on tensile failure.
